(19) United States
(12) Patent Application Publication
(10) Pub. No.: US 2008/0053222 A1
(43) Pub. Date: Mar. 6, 2008

(54) SINGLE USE, SELF-CONTAINED ASSAY DEVICE FOR QUANTITATIVE AND QUALITATIVE MEASUREMENTS

(75) Inventors: Jakob Ehrensvard, Taby (SE); Leif Henrik Eriksson, Sundbyberg (SE); Fredrik Carl Stefan Einberg, Huddinge (SE); James Richard Jackson, Hampshire (GB); Christer Bostrom, Akersberga (GB)

Correspondence Address: CONNOLLY BOVE LODGE & HUTZ LLP, 1875 EYE STREET, N.W., SUITE 1100, WASHINGTON, DC, 20036, US

(73) Assignee: CYPAK AB, Stockholm (SE)

(21) Appl. No.: 11/733,396

(22) Filed: Apr. 10, 2007

Related U.S. Application Data
(63) Continuation of application No. PCT/EP05/10879, filed on Oct. 6, 2005.

(51) Int. Cl. G01D 11/24

(52) U.S. Cl. 73/431

(57) ABSTRACT

The invention comprises a single-use, self-contained measuring device, comprising a data entry- and sampling part including a sensor for measuring of physical or chemical property of a foreign substance and a data acquisition part including electronic processing- and storage means, where the parts are integral parts of a packaging, formed of a sheet-like, printable and foldable material, the packaging being designed to enclose and protect the parts contained therein. The packaging may also include various instruments needed to perform a test.

### CROSS REFERENCE TO RELATED APPLICATIONS

This application is a Continuation under 35 USC 120 of International application PCT/EP2005/010879 filed on Oct. 6, 2005. International application PCT/EP2005/010879 claims benefit under 35 USC 119(e) to U.S. provisional application Ser. No. 60/522,529 filed on Oct. 11, 2004. The entire contents of each of these applications are incorporated herein by reference.

### BACKGROUND

This disclosure relates to the field of single use, self-contained assay devices for quantitative and qualitative measurements of samples and where the measurement results are stored in the device and can be collected for further analysis at a remote location.

Recent developments in microelectronic- and biochemical sensor technologies have created a substantial range of electronic devices for quantitative and/or qualitative measurements. Self-diagnostics in healthcare, where patients use low-cost diagnostic equipment to perform, primarily quantitative measurements, on different body fluids can be used to perform screening of potential diseases. Considering the costs involved in screening a potential large number of individuals in a population for severe conditions is generally not practical, nor cost efficient to conduct. As a very evident example, the growth of type II diabetes, primarily in the western world, puts an enormous burden on the healthcare systems at the same time it severely affects quality of life for the individuals affected. Different studies suggest that several percent of the population in an average western country can be on a dangerous trail, with a high risk of developing diabetes at a later stage. Early detection of diabetes can prevent the outbreak of disease, or at least delay it, if proper measures are taken. However, as this is a “silent disease”, diabetes is most of the time diagnosed too late, in a stage where no simple measures can be taken to halt the development of diabetes. At this stage, oral- or subcutaneous administration of insulin is the only remedy and the treatment is typically for the rest of the life. Further, over the years as the disease progresses, additional diseases typically evolve.

For patients with diagnosed type II diabetes that are put on insulin treatment it is essential to continuously monitor the glucose level in order to ensure that the insulin dose is correct. In a hospital setting, the glucose level can be quantified very accurately in a lab test. However, this is impractical for daily insulin administration at home, as the glucose level needs to be monitored closely. Today, several devices are found in the market to perform quantitative glucose level measurements, which typically comprise an electronic device and single-use sensor strips, which are disposed of after usage. In order to get an accurate reading, calibration data for the sensor being used needs to be supplied and proper temperature calibration needs to be performed. This in turn requires additional training and introduces sources of errors.

However, in order to effectively screen a large number of individuals in a group, several practical concerns arise with the methods described above. Sending blood samples to a centralized lab facility would require a special courier service as blood samples are considered to be a biohazard and can therefore typically not be sent by mail. Further, very tight routines must be followed in order to ensure that samples are not lost or mixed up. Another option of calling in a large number of individuals to a centralized location would simply be too expensive for a screening scenario. Timing is also an important factor, where several test require a short time from the time the sample is taken to the time the analysis is performed.

Commercially available electronic devices as mentioned above could in theory be an option, but the logistics and capital costs involved, together with required training, would make this option less practical to implement.

Further, it is commonly known that the so called “Fasting Glucose Test” is the most accurate, as the test is performed as the first task in the morning. However, in a practical hospital setup this is very impractical to implement.

Diagnosis and monitoring of other diseases and/or medical imbalances, such as blood cholesterol, blood hemoglobin and infectious diseases show similar practical problems. Apart from blood sampling test, other bio-sampling test, such as saliva, urine, feces, semen and sweat all share the obvious logistical and practical problems from a diagnostic standpoint.

An adjacent problem domain addresses field lab tests in a wide variety of applications, such as chemical analysis in industrial plants, soil analysis, drinking water analysis etc. All having in common that a sample is to be analyzed for at least one given property and that the test is typically performed at a centralized laboratory.

Given this particular application of screening, field monitoring and diagnosis, it would therefore be desired to have a simple to use, single use and self-contained assay device, which could be mailed out to a large number of individuals and the results being sent back for analysis.

In EP 0972196 is described an assay and recording means, where the recording means is detachable from the assay means. The device is manufactured from a durable material like reinforced plastics. The recording part may be detached via a perforated means or via a click, hasp, lock or the like. The assay part has a sample application well in fluid connection with a conduit, where the well or conduit or both contain materials for sampling a sample and a test ready indicator whereby the user can determine when a sample has been suitably assayed. The detachable part contains a recording device which is in data communication with the assay part and which is adapted to store information relating to the sample.

Another disposable electronic assay device is described in EP 0722563 (published as WO 95/06240. There a disposable assay device has a card-like housing for a sample receptor and a sample treatment means in order to yield a signal correlating with the amount of analyte in the sample and means for converting the electrical signal to a digital test result output means for presenting the test result output.

A problem with the prior art concerns the design of a device which can be easily manufactured and distributed to the users and the recorded data be collected for further analysis by a central unit. Allowing for cost-effective and secure screening of data give large advantages to the fields of application and diversity of geographical regions where tests can be performed.

From a quality assurance perspective, it may also be important to register the time of an event and temperature conditions during handling of the device.

### BRIEF SUMMARY

This disclosure describes a single-use, self-contained assay and diagnostic device, comprising a data entry- and sampling part including a sensor for measuring of physical or chemical property of a foreign substance and a data acquisition part including electronic processing- and storage means, where the part are integral parts of a packaging, formed of a sheet-like, printable and foldable material, the packaging being designed to enclose and protect the parts contained therein. The packaging may also include various instruments needed to perform a test.

From a convenience standpoint, it is desired to pack a sample as a kit, holding all necessary pieces together in a self-contained packaging, where the packaging serves multiple purposes.

The device can be mounted in flat shape and be folded into a self-contained package. This simplifies the manufacturing process considerably.

The packaging can further be designed so that after a conducted measurement, where a substantial part of the packaging is not needed in order to hold the collected data can be disposed of. Further, as the sensor gets contaminated by chemical and/or biological substances, it is also desirable that this part is removed and disposed of. By designing the packaging to have one part that holds the data processing- and storage means, the rest of the packaging can be torn off and disposed after a measurement is completed. The part holding the data can then be stored for further analysis. If equipped with a contact-less communication interface, information can be automatically exchanged with a host computer system.

A typical bio-sensor is an electro-chemical (redox-type) thermodynamic system, relying on either a potentiometric- or amperometric response relationship or a combination thereof. The sensor response is usually highly temperature dependent. An aspect of the invention is therefore to provide temperature sensing means to be able to compensate the recorded response for temperature deviations. Further, a temperature sensor can be used to alert the user that the temperature is too high or too low to perform an accurate measurement.

Further, as freezing and/or melting can potentially invalidate results from bio-sensors, the presence of a temperature sensor can also be used to ensure that the assay device has not been exposed to temperature extremes during storage and transportation.

Depending on the sensor chemistry, additional measures may need to be taken in order to monitor humidity, as this can affect the reliability of the reading. Either a desiccant or a moisture-sensor may then be added in order to compensate for a change in humidity, or signaling a void condition if the influence of humidity has been too high.

Whereas a described embodiment presents a diagnostic device for quantitative measurement of blood glucose in diabetes screening, the same basic setup can be used for other diagnostic applications. In healthcare applications, samples are often taken from blood, saliva, urine, sweat, mucus, pus, wound fluid, semen or feces; all having in common that is unpleasant, potentially hazardous and difficult to handle from a logistical perspective. Having a detachable design, where the contaminated part is irreversible detached from the data carrying part, solves this problem.

From an auditing standpoint, having an audit trial, where all recorded events and data points are time-stamped and paired with a unique identity, increases confidence in the collected data and ultimately yields more reliable results. The integrity of the data can be further enhanced by using the data processing means to add digital signatures to the results, which can be verified in order to ensure their authenticity when data is transmitted from the assay device to a remote database.

In some applications, additional information may be needed to be collected prior to storing the test results. By integration of an electronic questionnaire, for example such as described in U.S. Pat. No. 6,628,199, subjective or other information from the device user can be collected and stored in electronic form together with converted objective data.

Further, in some applications there may be a legal and/or non-repudiation aspect of a sample, where only an informed or trained person is allowed to perform the test or there is a concern that a test is performed by anyone else than the intended person. Such tests may include monitoring or detection of illegal substances found in blood and/or urine tests, where substances may be doping- or narcotic substances. The design of a self-contained packaging with an integrated microprocessor- and storage means further allows the integration of a keypad in the packaging, a user identification and authentication scheme can be implemented, where the intended person is informed with a secret- or identifying code prior to executing the test by another channel than the one used to distribute the device itself. By considering such an input as a PIN entry, it could be used in place of a signature by the person performing the test.

However, in general, the assay device can be designed with a minimum of user interaction functions in order to minimize costs and it can be assumed that some applications would not have any input means at all, except the sensor itself. On the other hand, additional means to interact with the user and to synchronize an expected set of actions, a sound element and additional visual indicators can be added. If the test is for a non-clinical setting, there may be some on-chip diagnostics, which signals the outcome of the test, such as “positive” or “negative”. A typical audible indicator would be a piezo-electric speaker, where typical visual indicators could be either a Light Emitting Diode (LED) or a printed electro chrome ink.

However, it is fairly obvious that the application areas are not limited to self-diagnosis in healthcare settings. Biochemical analysis of drinking water, industrial samples, soil samples, food, beverages etc. can be conducted by untrained personnel, by simple deployment of a “sample kit”, which can be sent to the desired site of sampling. When the test has been completed, the data carrier is torn off and sent back in a pre-printed and pre-paid return envelope to the test center for subsequent analysis.

### BRIEF DESCRIPTION OF THE DRAWINGS

FIG. 1 shows an assembled assay device.

FIG. 2 shows an opened assay device.

FIG. 3 shows a detached data carrier part and a sensor part of an assay device.

FIG. 4 shows an exploded view of the packaging part.

### DETAILED DESCRIPTION

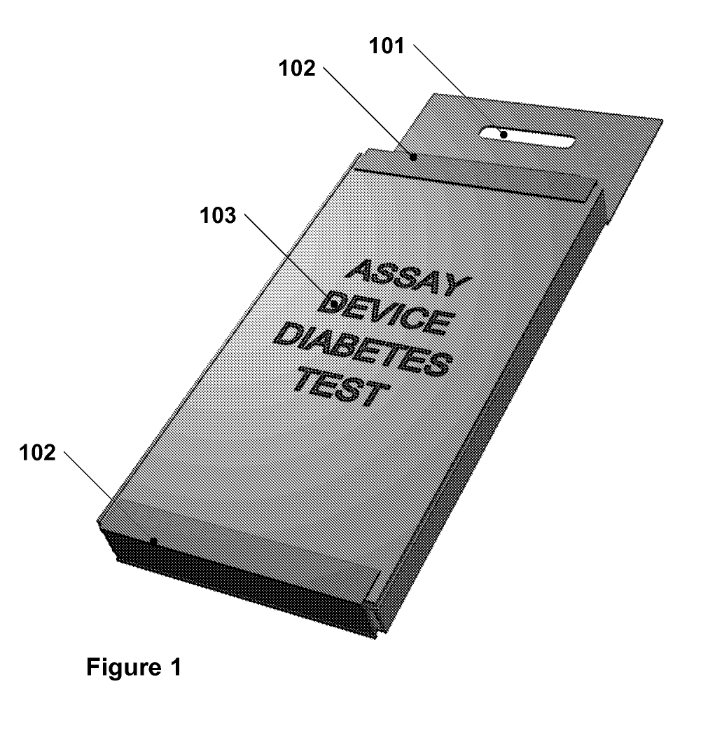

FIG. 1 shows an assay device prior to shipment. The device and its packaging are designed to be self-contained and all parts being protected by the packaging. A cut-out (101) together with informational text (103) allows the device to be put on a typical store display. The packaging comprises recesses (102) which are broken prior to usage.

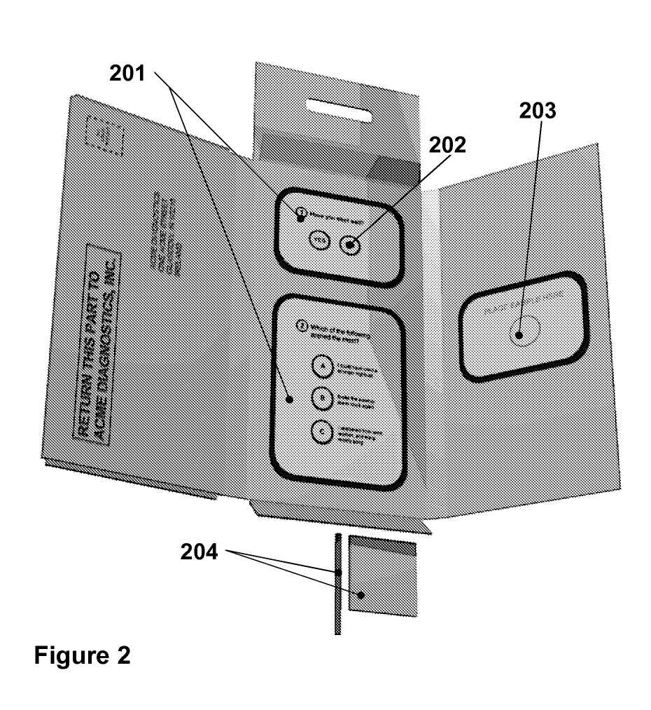

FIG. 2 shows an assay device prior to usage. The device and its packaging have been opened by breaking the recessed areas (102 in FIG. 1). The user is presented with a set of questionnaire panels (201) with embossed buttons (202) and a sample area (203). Additional items needed to perform or prepare the sample, such as a lancet and a wipe (204) are included, preferably attached by a pressure sensitive adhesive on the inside of the package.

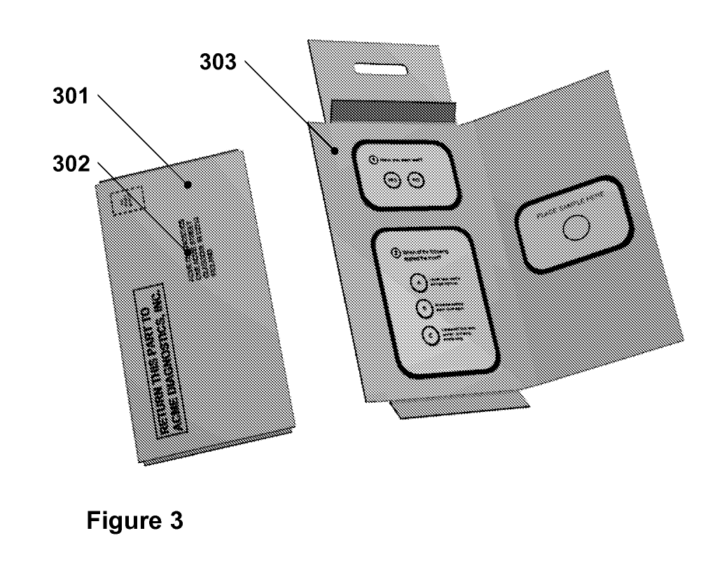

FIG. 3 shows an assay device at a completed sample. The data acquisition part (301) is separated from the data entry- and sampling part (303), where the latter can be disposed of as ordinary household waste, together with the additional items (204). As the sample area will be contaminated with for example blood when the test is completed, additional means of sealing the data entry- and sampling part prior to disposal, such as a line of adhesive may be included. The recorded data is then sent back to a centralized location for data retrieval. The part (301) can be sent by ordinary mail and be provided with a pre-printed address field (302) to allow it to be put into a mailbox.

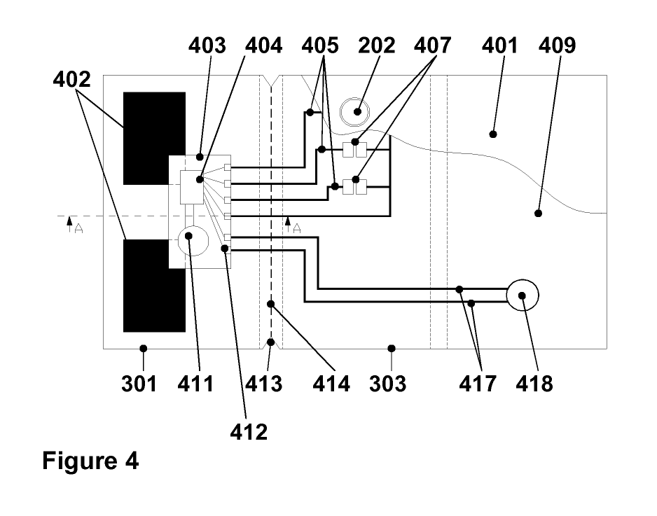

FIG. 4 shows an assay device exposed in a simplified exploded planar view. The device comprises a laminate of a bottom sheet (401) and a top sheet (409). The device comprises two parts (301, 303), separated by a hinged recessed area (414) and a cut-out area (413) to allow the parts to be easily separated by tearing. The data acquisition part (301) comprises an electronic module (403) with an electronic chip (404), a power source in form of a battery (411) and connector means (412), said connector means having corresponding printed connection points on the printed sheet (401). The electronic means is connected to the bottom sheet (401) with its printed antenna patches (402) using electrically conductive adhesive. The recording part (409) comprises embossed buttons (406) and a sensor (418), all being connected to the electronic module (403) using printed electrically conductive traces (405, 417). The buttons (406) are formed by printed switch-points in the bottom sheet and a printed area on the top part (407), where a mechanical force applied to the button (406) creates electrical connection between the pads (407). The sensor (418) is printed with an enzyme material, where the connecting traces (417) acts as electrodes. The sensor (418) is exposed to the user via a cut-out (not shown) in the top layer (409).

The electronic chip can be an ASIC comprising the following functions:
A microprocessor running an application program
A non-volatile data memory for storage of information
A real-time clock to give objective timestamps to stored events and data
A factory-programmed, unique identifier to allow linkage of a unique device to a record in a database
An on-chip temperature sensor for temperature compensation during data acquisition and for storage and transport temperature monitoring.
Signal conditioning means and analog/digital converter means to sample data from the sensor
A radio-telemetry communication interface to allow the device to be read through the packaging material, preferably compatible with an existing Radio Frequency (RFID) Identification standard such as ISO 15693, or low a cost alternative such as a capacitive system as described in application U.S. Pat. No. 6,615,023.
A cryptographic subsystem to allow information being sent from and to the device to be encrypted and/or cryptographically signed.

In order to facilitate production the device is produced in two parts. The two parts are then assembled to the finalized product.

Part 1 with the electronics module (403) with ASIC (404), battery (411) and supporting components are assembled on a thin polymer film, for example a polyester film with etched copper. The film has fine-pitch conductors which are spread to large pads (412), which can be attached to a substrate having conductors with a coarser pitch. The ASIC is mounted with stud-bumps or by conventional bonding to the metal on the film.

Part 2 is the actual packaging. The packaging is produced using methods and equipment, well known to the industry. A sheet of polymer coated paperboard is printed with traces of conductive ink (417, 405), said traces forming a “disposable circuit-board”, where the polymer coating is used to minimize influence of moisture in high-sensitivity measurements. Depending on the requirements, it has been found that conductive inks of either carbon-graphite or silver give good performance. The traces connect the sensor (418) and printed pressure-sensitive keys (406) to a matrix of conductive pads (412) for connection to the electronics module (403). State-of-the-art methods are then used for application of additional printed graphics (103), cutting, embossing and creasing. Membrane pressure-sensitive keys (406), as described in application U.S. Pat. No. 6,628,199, are formed by applying conductive ink areas on facing sides of the polymer coated paperboard, which is then made into a membrane by lamination. Preferably, an antenna used for contact-less communication (402, 410) is also printed on the polymer coating. As a final step, the sensor (418) is applied using thick-film printing of the sensor compound, where the conductive ink (417) described also forms the sensor electrodes. Alternatively, the sensor can be applied as a finished third-party component. Such sensors are typically delivered as strips with connection electrodes. In such an arrangement, an electrically conductive adhesive is printed onto conductive lines in the packaging.

Assembly of the device is made by having Part 1 with the electronics module applied onto the Part 2 paper substrate at the place of the printed conductor pad matrix (412), using an electrically conductive adhesive. The product is then folded together and heat-sealed, using a printed or sprayed heat-activated adhesive.

Prior to deployment, the electronic module needs to be initialized with time from an accurate time source and optional calibration data for the sensor. Further, depending on the sensor type and chemistry, a reference voltage calibration step may be needed. In order to conserve battery power, the power consumption for the ASIC is very low when not initiated. When the clock and calibration data has been initialized, the product is ready to use. The necessary battery capacity should be calculated for the anticipated time period from deployment to usage. On the other hand, this time is generally limited by the shelf-life of the sensor compound. Some sensors may be sensitive for low and/or high ambient temperatures even at storage. By utilizing the temperature sensor in the ASIC, the ambient temperature can be continuously monitored. If the temperature limits for the sensor has been exceeded, the user will be alerted that the device will not deliver expected results. Alternatively, if the sensor has a known temperature and/or aging profile, proper adjustment and re-calibration can be performed at time of conversion.

A usage scenario may be described as:

The assay/diagnostic device kit is assembled at a centralized manufacturing site, containing all necessary items and information which is needed to perform the desired test.

The device is delivered to a patient by ordinary mail services. The packaging is designed to withstand normal abuse and humidity fluctuations expected during transport and storage. In order to minimize waste and material usage, the packaging is made an integral part of the diagnostic device.

The user physically opens the enclosing package by rupturing recessed areas (102) in the sealing design of the packaging. When opened, the integrated electronics detects the opening and switches the operating mode to “active”. A timestamp is stored in the memory of the electronics module to keep a record when the package seal was broken. At the time the kit is opened, the device performs a self-test and verifies that the kit is undamaged and that there have been no temperature extremes during transport and storage.

In order to explicitly synchronize the desired measurement operation, the user presses a start button, which is embossed into the packaging material. When said start button is pressed, a timestamp is stored in the memory of the electronics module. From a usability viewpoint, the inside of the kit is printed with instructions how to perform the test. The “start” button would then be labeled “Press this key when you have read and understood the instructions how to perform the test”.

A reminder signal and/or visual indicator prompts the user to respond to a limited number of questions (201) related to the measurement to be performed. The entry is performed on embossed buttons (202), and the responses are recorded and stored in the memory of the electronics module, together with a timestamp.

A different reminder signal and/or visual indicator prompt the user to expose a blood sample to the sensor (203, 418). The electronics module continuously monitors the sensor and a significant change in a physical property signals the presence of the sample on the sensor. Depending on the sample and the sensor chemistry, the actual sampling by the electronic module is performed for a predetermined time. For the convenience of the user, the packaging holds a sterile lancet and a disinfectant cleaning swab.

When the sampling is finished, the user is alerted that the measurement is completed.

If the device user has additional comments or information which needs to be conveyed to the location where the data carriers are analyzed, said information is then written on a write-pad on the data carrier part. In order to avoid manual reading or additional optical scanning of all data carriers and to get an objective time-stamp for when that information was written, the write pad is made pressure sensitive. When the write pad is affected by the pressure of the pen, this is recorded and time-stamped by the data processing- and storage means.

The user then tears or cut apart the packaging along clearly marked recessed area of the packaging (413), thereby separating the data acquisition part with its stored data (301) and its enclosure and the other parts (303), which are no longer needed to gather and convert the sample.

The used and now useless part (303), including the contaminated sensor, is disposed of in normal waste by the device user. The disposable part is designed in such a way that it can be folded together and be sealed prior to disposal and further to hold the used lancet and swab.

The “data carrier” has a pre-paid stamp and a return address printed on one side (302) and the user puts it in normal mail for return to a centralized data scanning facility.

At the centralized data scanning facility, the “data carrier” part (301) is read by a RFID scanner and the result is transferred to a centralized database. Featuring long range RFID technology with anti-collision capabilities, a large number of data carriers can be scanned, even when stored in a mail bag, at high speed.

When the data arrives into a centralized database, a server-based application decrypts the data and verifies the digital signature. The data may then require additional processing in order to be converted to a useful result.

If additional information has been entered, as described in step 6 above, the automated scanning detects that information is present on the write pad. The data carriers having this information would then require manual reading and data entry

Although the above usage scenario presents recording and conversion of a single sample only, it should be obvious that a device could be arranged to feature multiple sensor sites to allow several tests to be performed over a longer period of time. Further, depending on the test requirements, it may be useful to monitor more than one foreign substance at the same time. In such a setup, several sensors may be arranged in close planar to each other proximity in such a way that a sample evenly distributes over all individual sensors.

What is claimed as new and desired to be protected by Letters Patent of the United States is:

1. A single use, self-contained measuring device comprising: a data entry- and sampling part including a sensor for measuring a property of a foreign substance and a data acquisition part including electronic processing and storage means, wherein the data entry- and sampling part and the data acquisition part are integral parts of a packaging, formed of a sheet-like, printable and foldable material, the packaging being arranged to enclose and protect parts contained therein.

2. A device in accordance with claim 1, wherein the foldable material comprises a laminate comprising a bottom sheet and a top sheet, an electronic module applied on a flexible film is fixed and conductive traces are printed on the bottom sheet and the bottom sheet and the top sheet are bonded together on top of each other by an electrically conductive adhesive layer.

3. A device in accordance with claim 1, wherein the sensor is printed on the bottom sheet and connected to conductive traces connected to the electronic module.

4. A device in accordance with claim 1, wherein the sensor is attached to the bottom sheet by an electrically conductive adhesive layer.

5. A device in accordance with claim 3 wherein the device comprises a plurality of sensors to allow several acquisitions to be performed at more than one single event or several measurements to be performed on a single acquisition.

6. A device in accordance with claim 4 wherein the device comprises a plurality of sensors to allow several acquisitions to be performed at more than one single event or several measurements to be performed on a single acquisition.

7. A device in accordance with claim 2 wherein the bottom and top sheets are covered with moisture barrier layers.

8. A device in accordance with claim 1 wherein the data acquisition part is detachable from the data entry- and sampling part.

9. A device in accordance with claim 8 wherein each detachable part is uniquely marked to allow parts from different devices to be identified after having been detached.

10. A device in accordance with claim 1, wherein the packaging may contain an additional item needed for performing the measuring.

11. A device in accordance with claim 1 wherein the data acquisition part comprises an electronic module comprising an electronic chip, a power source and data communication means for exchanging data, the chip having data acquisition means, data processing means, a non-volatile data storage means and time-keeping means, the time-keeping means being used to attach a time-stamp to generated data stored in the data storage means.

12. A device in accordance with claim 11 wherein the electronic module comprises connection points connected to corresponding printed connector means for connecting the electronic module to printed conductive traces connected to the sensor on the data entry- and sampling part.

13. A device in accordance with claim 11 wherein the electronic chip have a temperature measuring means in order to quantify the temperature in proximity to the sensor.

14. A device in accordance with claim 12 wherein the electronic chip comprises a temperature measuring means in order to quantify the temperature in proximity to the sensor.

15. A device in accordance with claim 12 wherein the temperature measuring means provide a quantified value of the ambient temperature value at the time the acquisition is taking place and said temperature value is being used as an operator in converting temperature dependency of a result of the measuring.

16. A device in accordance with claim 13 wherein the temperature measuring means is used to monitor if permissible temperature limits of the device has been exceeded in the lifecycle of the device from production to a point when the acquisition is completed.

17. A device in accordance with claim 15 wherein the temperature measuring means is used to monitor if permissible temperature limits of the device has been exceeded in the lifecycle of the device from production to a point when the acquisition is completed.

18. A device in accordance with claim 11, wherein the time-keeping means is initialized from a centralized time source and the time-keeping means is maintained by the power source up to the point when the acquisition has been completed and is thereafter switched off to conserve power.

19. A device in accordance with claim 11, wherein the electronic module comprises an audible means or optically visible means to interact with the user of the device.

20. A device in accordance with claim 19, wherein said optically visible means are shapes printed on the bottom sheet surface using electro-chrome ink.

21. A device in accordance with claim 11, wherein the device comprises a compartment containing a desiccant to remove moisture and improve reliability of the measuring by the sensor.

22. A device in accordance with claim 1, wherein the data communication means is used to exchange data between the data processing means and an external host computer for receiving data.

23. A device in accordance with claim 1, wherein the packaging comprises an additional part having a questionnaire panel allowing a user of the device to give additional remarks.

24. A device in accordance with claim 1, wherein the acquisition part comprises a card provided with a preprinted address field allowing the part to be mailed or collected after detachment from the data entry- and sampling part, without additional activity of the user of the device.
